(19) United States
(12) Patent Application Publication
(10) Pub. No.: US 2009/0297736 A1
(43) Pub. Date: Dec. 3, 2009

(54) Foldable door mat

(76) Inventor: James Keighley, West Yorkshire (GB)

Correspondence Address: WILEY HORTON, 215 SOUTH MONROE STREET, 2ND FLOOR, TALLAHASSEE, FL, 32301, US

(21) Appl. No.: 12/154,978

(22) Filed: May 29, 2008

(51) Int. Cl. B32B 3/00

(52) U.S. Cl. 428/12

(57) ABSTRACT

A foldable planar door mat has formed integrally therewith at least one hinge 4, 8, 9, 14, 16, 17 extending across one dimension of the covering to enable at least a section 2, 3, 5, 6, 7 of the covering to be folded over to lie on top of and flush with the surface of an adjacent section of the covering. It is possible to have a further hinge 15 located at 90° to the said at least one hinge.

### CROSS-REFERENCES TO RELATED APPLICATIONS

This application claims priority—pursuant to 35 U.S.C. section 119—to an earlier-filed foreign application. The foreign application was filed on 31 May 2008 in the United Kingdom Patent Office. It was assigned UK Patent Application No. 0710440.9. UK Pat. App. No. 0710440.9 lists the same inventor and has been assigned to Primeur Limited.

### STATEMENT REGARDING FEDERALLY SPONSORED RESEARCH OR DEVELOPMENT

Not Applicable.

### MICROFICHE APPENDIX

Not Applicable

### BACKGROUND OF THE INVENTION

1. Field of the Invention

The present invention relates to the field of floor coverings. More specifically, the invention comprises a foldable, planar door mat.

2. Description of the Related Art

The storage, transport and, in particular, the display of door mats in retail outlets causes problems because of the bulk of the product and the fact that a typically sized doormat, for example, is far too large for standard size shelving, which creates problems in storage in warehouses and stores, and in retail outlets inevitably means that the mats have to be stacked on the floor and cannot be displayed adequately. It is known to roll up such mats but this is extremely inefficient and wasteful of shelf space particularly, since the product cannot be satisfactorily stacked on top of each other when they are rolled up, since inherently any such stable pile will be unstable. Again, the product cannot be satisfactorily displayed to the potential purchaser when rolled tip. These problems increase costs for storage and transportation and potentially reduce sales because of the difficulties in adequately displaying the product.

The present invention seeks to provide a solution to these problems.

### BRIEF SUMMARY OF THE PRESENT INVENTION

The present invention comprises a foldable planar doormat having at least two sections and a foldable hinge connecting the sections. In a preferred embodiment the doormat is made of a backing layer bonded to a matting layer. The foldable hinge is formed integrally in the backing layer. The sections can be folded along the hinge so that they lie on top of each other in an orderly stack. Other embodiments include three or more sections.

### BRIEF DESCRIPTION OF THE SEVERAL VIEWS OF THE DRAWINGS

FIG. 1 is a perspective view, showing a foldable door mat having two sections with different surface finishes and joined by a film hinge.

FIG. 2 is a perspective view, showing a foldable door mat having three sections joined by two hinges in spaced parallel relationship,

FIG. 3 is a perspective view, showing a foldable door mat having two hinges, one normal to the other.

FIG. 4 is an elevation view, showing a foldable door mat in a folded state.

FIG. 5 is a detail elevation view, showing an alternate embodiment having two adjacent parallel thin film hinges.

FIG. 6 is a perspective view, showing an alternate embodiment made of a substantially rigid plastic material.

### REFERENCE NUMERALS IN THE DRAWINGS

2 section

3 section

4 hinge

5 contiguous rectangular section

6 contiguous rectangular section

7 contiguous rectangular section

8 hinge

10 square section

11 square section

12 square section

13 square section

14 hinge

15 hinge

16 hinge

17 hinge

19 section

21 hinge

22 hinge

### DETAILED DESCRIPTION OF THE INVENTION

According to the present invention there is provided a foldable planar doormat having at least two sections, and a backing layer having formed integrally therewith a hinge extending across one dimension of the mat to enable at least a section of the mat to be folded over to lie flush with the surface of an adjacent section of the mat, wherein the hinge comprises a thin film hinge formed in said backing layer of the mat.

The invention also provides a doormat formed of three contiguous sections, and having formed integrally therewith thin film hinges extending in parallel across one dimension of the mat to join said sections and to enable said sections of the mat to be folded over to lie flush with the surface of an adjacent one of said sections, one of the hinges being formed on an underside of the mat and the other of the hinges being formed on an upper side of the mat, to enable the three sections to be folded in a Z-shape.

In another preferred embodiment, a further hinge is provided extending across a dimension of the covering normal to said one dimension, to enable the covering to be folded into a quarter of its open size.

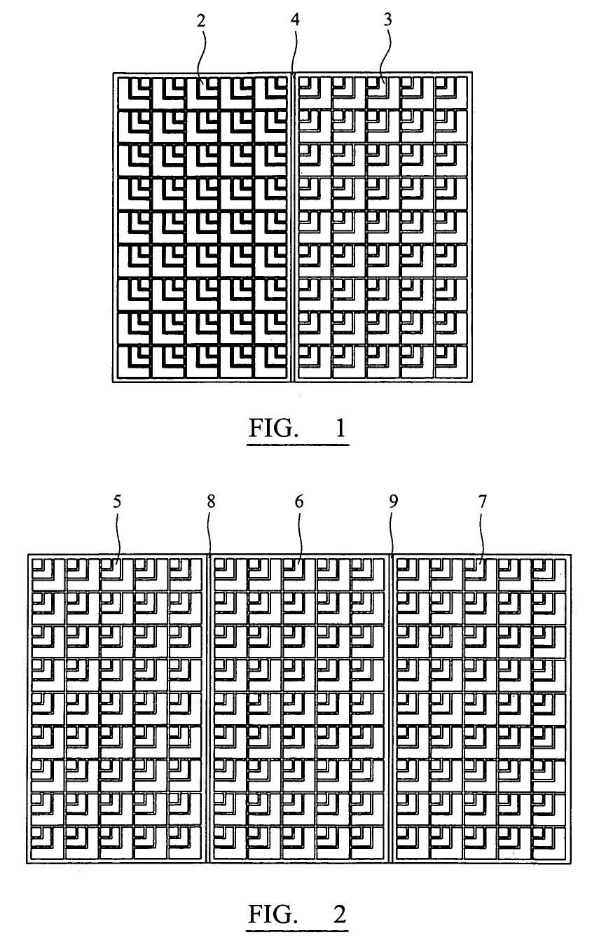

Referring now to FIG. 1 of the drawings, there is shown a doormat having two rectangular sections, each having a different surface pattern and profile, section 2 having a relatively hard smooth rubber or plastics finish and the section 3 having a textile finish. The two sections 2, 3 are mounted on a backing sheet (not shown) with two of the longer sides being essentially contiguous, and at this junction, the backing sheet forms or incorporates a thin film hinge 4 about which the two sections are relatively pivotable to enable the two sections to be folded about the hinge line. In this way, the undersides of the backing sheet on the two sections abut each other so that the two sections lie flush closely abutting each other and substantially parallel. In this position the mat can be more easily placed on a shelf and, for storage purposes, other mats may be placed on top of it to build up a pile of mats in a stable pile.

Referring now to FIG. 2, there is shown a doormat which incorporates three contiguous rectangular sections 5, 6, 7, which are of substantially the same size, and joined by a thin backing sheet incorporating two spaced parallel film hinges 8 and 9. FIG. 4 shows an end view of this embodiment in a folded condition for storage, in which the sections are folded over in a fan-fold or a Z-shaped manner.

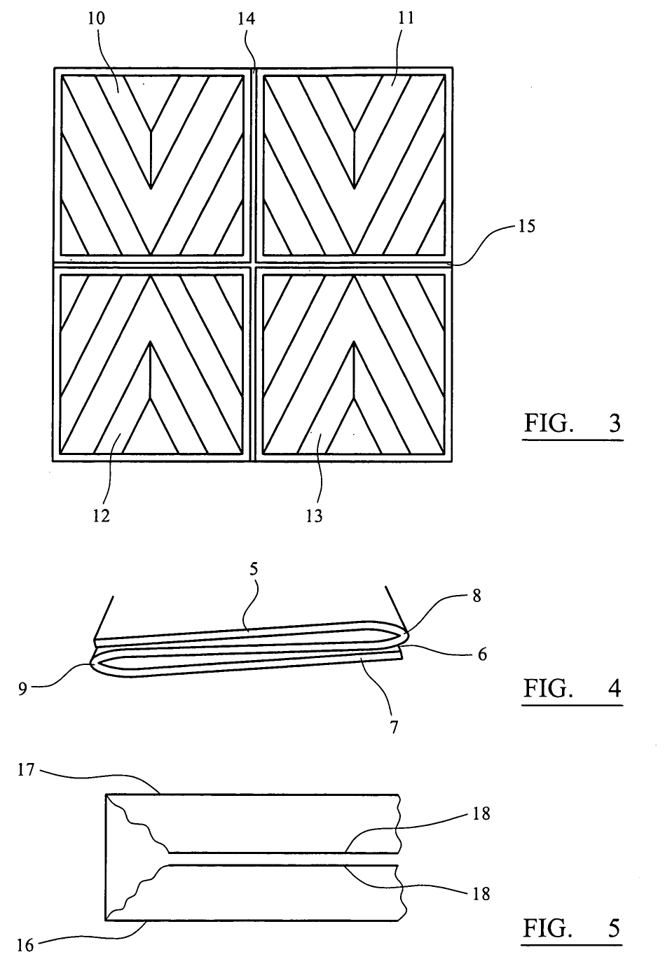

FIG. 3 illustrates a further embodiment of a doormat in accordance with the present invention, which consists of four generally square sections 10, 11 12, 13 mounted on a backing sheet which incorporates two film hinges 14, 15 located normal to each other. In this way, the two sections 10 and 12, can be folded to lie under the sections 11 and 13 respectively by a pivotal moment about the hinge 14. Thereafter, the two sections can be folded about the hinge 15 so that the surface of the section 11 lies on top of the surface of the section 13. In this way, the carpet can be stacked on a shelf, covering only a quarter of the surface area of the opened mat.

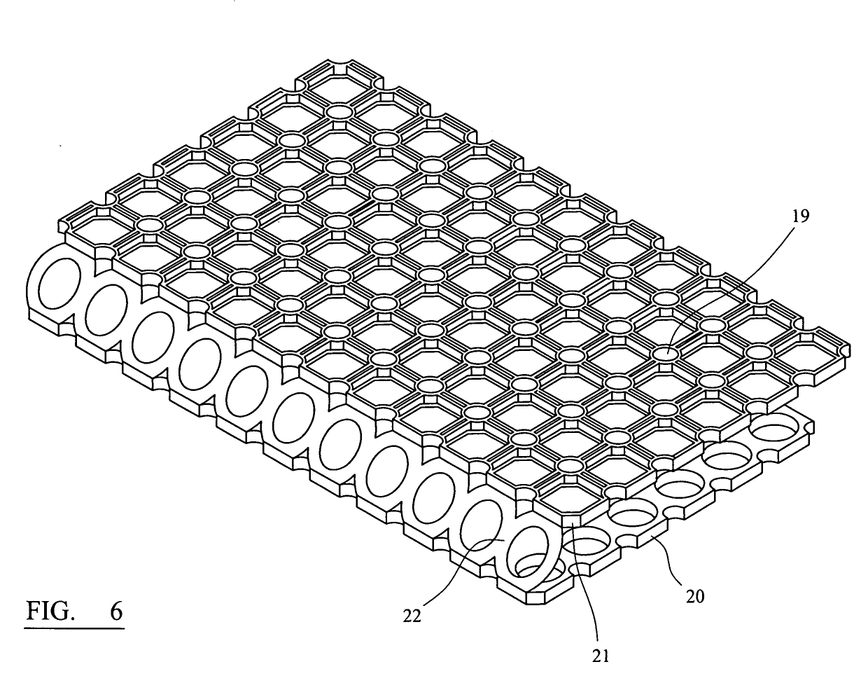

Referring now to FIG. 5, there is shown a development of the concept which would be useful in particular for very thick mats such as the coir matting used for door mats. In this development, instead of having just one film hinge in the backing strip, the backing strip has two film hinges 16, 17 in parallel relationship and sufficiently close to each other to enable the two sections of the mat to be folded over to lie essentially flush one on the other without causing excessive distortion or squashing of the surface pile or coir 18 of the mat which might otherwise occur in the region of the hinge is only a single hinge were used.

FIG. 6 shows a further embodiment, of a doormat, which is formed of a substantially rigid plastic material having an open lattice type construction. The mat has two sections, 19 and 20, joined by two thin film hinges 21 and 22 located on one face of the mat. In a development of this form of mat, the mat may be formed of three contiguous sections hingedly joined together by parallel thin film hinges. To enable the mat to be folded up into a flat Z-shape, one of the thin-film hinges is located on the underside of the mat and the other thin-film hinge is located on the upper side of the mat

It will be appreciated that many variations may be made to the basic layout. For example, the three section doormat illustrated in FIG. 2 could equally have a further hinge (not shown) located at 90° to the two hinges 8 and 9 to enable the mat to be folded in half in the plane at 90° to the hinges 8 and 9.

Although the preceding description contains significant detail, it should not be viewed as limiting the invention but instead as providing illustrations of the preferred embodiments of the invention. Thus, the scope of the present invention should thus be defined by the following claims rather than any specific examples given.

Having described my invention, I claim:

1. A foldable planar doormat having at least two sections, and a backing layer having formed integrally therewith a hinge extending across one dimension of the mat to enable at least a section of the mat to be folded over to lie flush with the surface of an adjacent section of the mat, wherein the hinge comprises a thin film hinge formed in said backing layer of the mat.

2. A mat according to claim 1, wherein two thin film hinges arranged in spaced parallel relationship are provided.

3. A mat according to claim 1, wherein a further hinge is provided arranged at 90° to the first mentioned hinge.

4. A mat according to claim 1, wherein the said at least two sections each have a different surface.

5. A doormat formed of three contiguous sections, and having formed integrally therewith thin film hinges extending in parallel across one dimension of the mat to join said sections and to enable said sections of the mat to be folded over to lie flush with the surface of an adjacent one of said sections, one of the hinges being formed on an underside of the mat and the other of the hinges being formed on an upper side of the mat, to enable the three sections to be folded in a Z-shape.

6. A doormat according to claim 5, formed of a substantially rigid plastics material having an open lattice type constriction.

7. A mat according to claim 2, wherein a further hinge is provided arranged at 90° to the first mentioned hinge.

8. A foldable planar doormat, comprising:
a. a first rectangular section having a first joining edge, a lower surface, and an upper surface made of hard smooth rubber or plastic;
b. a second rectangular section having a second joining edge, a lower surface, and an upper surface having a textile finish;
c. a backing sheet, including a thin film hinge;
d. wherein said lower surface of said first rectangular section is bonded to said backing sheet;
e. wherein said lower surface of said second rectangular section is bonded to said backing sheet with said second joining edge lying proximate to and parallel to said first joining edge; and
f. wherein said first and second joining edges lie proximate to said thin film hinge in said backing sheet.

9. A foldable planar doormat according to claim 8, further comprising:
a. wherein said second rectangular section has a third joining edge;
b. a third rectangular section having a fourth joining edge, a lower surface, and an upper surface;
c. wherein said backing sheet includes a second thin film hinge;
d. wherein said lower surface of said third rectangular section is bonded to said backing sheet with said fourth joining edge lying proximate to and parallel to said third joining edge; and
e. wherein said third and fourth joining edges lie proximate to said second thin film hinge in said backing sheet.

10. A foldable planar doormat as recited in claim 8, wherein:
a. said first joining edge has a bevel having an upper extreme and a lower extreme;
b. said second joining edge has a bevel having an upper extreme and a lower extreme; and
c. said upper extremes of said bevels on said first and second joining edges are further apart than said lower extremes of said bevels on said first and second joining edges.

11. A foldable planar doormat as recited in claim 10, wherein said lower extremes of said bevels are separated by a distance about equal to the thickness of said first rectangular section combined with the thickness of said second rectangular section.

12. A foldable planar doormat as recited in claim 1, wherein:
a. said first of said at least two sections has a first joining edge;
b. said second of said at least two sections has a second joining edge;
c. said first joining edge has a bevel having an upper extreme and a lower extreme;
d. said second joining edge has a bevel having an upper extreme and a lower extreme; and
e. said upper extremes of said bevels on said first and second joining edges are further apart than said lower extremes of said bevels on said first and second joining edges.

13. A foldable planar doormat as recited in claim 12, wherein said lower extremes of said bevels are separated by a distance about equal to the thickness of said first of said at least two sections combined with the thickness of said second of said at least two sections.
